(19) United States
(12) Patent Application Publication
(10) Pub. No.: US 2009/0110774 A1
(43) Pub. Date: Apr. 30, 2009

(54) HIGH ANTIOXIDANT LEVELS IN COCOA-BASED BEVERAGES

(75) Inventor: Joseph Milici, Hershey, PA (US)

Correspondence Address: WILEY REIN LLP, 1776 K. STREET N.W., WASHINGTON, DC, 20006, US

(73) Assignee: THE HERSHEY COMPANY, Hershey, PA (US)

(21) Appl. No.: 11/925,162

(22) Filed: Oct. 26, 2007

(51) Int. Cl. A23C 9/154; A23C 11/10; A23C 9/156; A23C 9/158

(52) U.S. Cl. 426/73; 426/311; 426/324; 426/330.2; 426/330.3; 426/519; 426/542; 426/584; 426/593

(57) ABSTRACT

The invention provides, in one aspect, a method of producing a ready-to-drink cocoa beverage containing high levels of beneficial cocoa polyphenols in a milk or soymilk base. The method incorporates an ultra high temperature treatment followed by a homogenization step. Cocoa powder levels can be selected from about 3.5% to about 10% by weight, while the mouthfeel, solution stability over time, and taste remain acceptable.

### FIELD OF THE INVENTION AND INTRODUCTION

The invention relates to new beverages made with high levels of cocoa, and consequently cocoa antioxidants, generally comprising a dairy or soy ingredient and high levels of at least one cocoa-containing product. Producing a beverage with high levels of cocoa powder, for example, will generally result in solution stability problems and can generate a rather astringent taste. The methods of the inventions allow the production of dairy and even soy base liquids to be combined with amounts of cocoa products not previously used or deemed palatable. The results are healthy products with intense chocolate flavor and beneficial amounts of cocoa antioxidants.

### RELEVANCE OF THE INVENTION AND DESCRIPTION OF RELATED ART

Manufacturers of ready-to-drink beverages appreciate the difficulties of producing an acceptable mouthfeel while at the same time preserving the suspension of ingredients in milk or other base liquids. This is especially difficult in refrigerated or iced products. Numerous mixtures of stabilizers, including micro-crystalline cellulose and various gum ingredients, have been used in this regard. Similarly, sterilization of milk-based beverages for the commercial storage conditions used can result in off-flavors from the enzymatic or other degradation of milk and other components. Accordingly, the stability of the initial mouthfeel, flavor, and suspension properties of these products is difficult to achieve in a commercial manufacturing setting.

More and more evidence shows the health benefits of cocoa antioxidants or cocoa flavanol compounds in the diet. However, adding cocoa products to a beverage in higher levels in order to deliver these health benefits, for example above the typical 1.5% by weight cocoa powder or the equivalent in cocoa solids of a chocolate milk product, causes taste problems in the bitterness inherently present in cocoa solids. Additional mouthfeel and suspension problems arise from the use of cocoa and the carageenans commonly present with cocoa in chocolate flavors.

The invention, in one aspect, addresses these problems with novel and improved manufacturing processes that produce a stable, highly intense cocoa flavor in beverages with high levels of cocoa flavanols. The ready-to-drink beverages possible from the invention can be stored for six months, or twelve months or longer at room temperature without degradation in taste, mouthfeel, or suspension, and thus can be produced as extended shelf life products.

### BRIEF SUMMARY OF THE INVENTION

The present invention relates to beverages with high levels of cocoa flavanols from cocoa solids or cocoa powder. The beverages are made using an ultra-high temperature heating process. In one embodiment, the ultra high temperature heating is about 290° F. or about 140° C. and can be used to swell the components in a milk-based or soymilk-based product with cocoa powder or cocoa solids. After this heating, the mixture is cooled and homogenized. In a preferred embodiment, the homogenization occurs at about 170° F., and a further preferred aspect employs aseptic homogenization, and in an especially preferred embodiment homogenization occurs after heating to aseptic conditions. One advantageous aspect of the method to produce the beverages is the ability to combine all ingredients once and then process to final filling. In contrast, many existing manufacturing processes require the addition of a separate stabilizer, or components with stabilizers and emulsifiers, and/or combine flavors, in a separate processing step, which potentially compromises the in-line production and sterile conditions.

In another aspect, the invention relates to beverages having a milk and/or soymilk base that contain high levels of cocoa powder, or the equivalent in cocoa solids, in the range of greater than 3.5% total cocoa powder by weight, or up to about 9% total cocoa powder by weight, or about 10% by weight total cocoa powder. Contrary to products with this high level of cocoa, the beverages of the invention can be made so that they do not display a bitter or astringent taste characteristic. Furthermore, the beverages have an acceptable mouthfeel, maintain a stable solution with substantially no bottom residue or separation after storage for up to 6 or 12 or more months, and are stable to room temperature and cooled storage conditions.

In one preferred embodiment, the invention comprises a method to produce a shelf-stable or extended shelf life extra dark chocolate shake product and the products themselves. In general, a shelf stable product is one that can be safely stored and sold in a sealed container at room temperature while still retaining its basic characteristics, such as remaining in suspension. The technology for extending the shelf life of products involves increasing the microbial reduction level during processing, avoiding re-contamination during filling, and maintaining a reduced microbial level during distribution temperatures. One of skill in the art is familiar with techniques to produce shelf stable and extended shelf life products according to the invention and any available technology can be used for these purposes. A whole milk, reduced fat milk, substantially fat-free milk, or a soymilk can be used as a base. The products can be made with about 3% natural cocoa powder by weight, and levels up to about 9% or about 10% can be produced, as well as any desired range between 3% and 10%. Most preferred is about 3.5% to about 4.5% total cocoa powder by weight, where the natural cocoa powder is from about 3% to about 4% of the total cocoa powder present. Thus, combinations of cocoa powder can be used in embodiments of the invention, such as where about 3% natural cocoa powder plus about 0.5% alkalized cocoa powder is used, and a variety of other combinations of natural cocoa powder, alkalized cocoa powder, cocoa powder from unroasted cocoa beans, cocoa powder from unfermented cocoa beans, and cocoa powder from unfermented/unroasted cocoa beans are possible to reach a combined level from about 3.5% to about 10% total by weight. The levels of natural cocoa powder or natural cocoa products present as compared to the levels of other cocoa products can be presented by a percentage of natural cocoa products to total cocoa products, so that, for example, between 80-90% of the total cocoa products present are natural cocoa products. Preferably, the combination of cocoa powders or products yields a stable, shelf stable, and/or extended shelf life product with antioxidant levels of about 10,000 umol TE per 8 oz serving (Trolox Equivalent in an Oxygen Radical Absorbance Capacity ORAC assay), or about 575 mg total polyphenols per 8 oz serving, or about 345 mg polyphenol monomers per 8 oz serving, or about 547 mg GAE per 8 oz serving (gallic acid equivalent). In particular, an 8 oz. serving can have more than 200 mg of total polyphenols (TP), or more than 500 mg TP, or more than 1,000 mg TP, or more than 1,500 mg TP. One of skill in the art is familiar with numerous and similar measurements for antioxidant capacity, and any method available can be used. In addition, the combination of natural cocoa powder and alkalized cocoa powder, and other cocoa powders, cocoa products or extracts, can provide a broad taste and bitterness profile and can be used to improve taste, bitterness, and color in a final product.

As noted, the methods and products use some or mostly natural cocoa or extracts that are not treated with alkaline, or alkalized cocoa. Natural cocoa and cocoa products that have not been treated with alkaline conditions have higher levels of cocoa flavanols, flavanol antioxidants, and cocoa polyphenols. However, a variety of cocoa powders, cocoa extracts, cocoa concentrates, cocoa compositions, cocoa solids, and cacao bean compositions are known and available to one of skill in the art and can be selected for use in any aspect of the invention. In addition, extracts with enhanced levels of cocoa flavanols or cocoa polyphenols, or extracts with additives, can also be selected for use and can be combined with the cocoa products mentioned above. Furthermore, combinations of cocoa powders, extracts, enhanced extracts, concentrates, extracts with additives can be selected and used for any aspect of the invention. The terms “cocoa solid” and “cocoa bean” compositions can be any of a variety of products and combinations as well as specific combinations of the cacao bean-derived products noted in this disclosure and/or available to one of skill in the art. Where “cocoa powder” is used, an equivalent amount or level of a cocoa solids-containing product can also be used, such as chocolate liquor, cocoa nibbles, baking chocolate, non-fat cocoa powder, and other cocoa products available.

In particularly preferred embodiments, the invention comprises beverages that contain efficacious cocoa polyphenols and/or cocoa antioxidants. These beverages can be used in a healthy diet, for example a diet to improve cardiovascular conditions or prevent cardiovascular disease or other diseases. Another aspect of the invention is to provide a cocoa beverage composition that is a no sugar added, sugar-free, low calorie, and/or substantially calorie-free cocoa beverage. Yet another aspect of the invention is to provide a cocoa beverage that is no sugar added, sugar-free, low calorie, and/or calorie-free or substantially calorie-free product and which optionally contains other available or known supplements, active ingredients, appetite suppressing agents, and similar agents or ingredients, especially those also found in antioxidant-containing plant products and foods, such as, but not limited to, herbs, teas, coffees, and berries. Further, the beverage compositions may be combined with one or more other dietary nutrients, such as vitamins, minerals, amino acids, sterols, plants sterols, omega-3 fatty acids, etc., to provide a nutritional or dietary supplement. Any of these combinations of the invention can advantageously provide benefits to human health and capture additional beneficial effects. All of the ingredients or combinations may be combined with appropriate stabilizers, preservatives, binders, emulsifiers, weighting agents, and other edible or ingestible compounds known to one of skill in the art in the industry to produce a beverage.

Throughout this disclosure, applicants refer to journal articles, patent documents, published references, web pages, and other sources of information. One skilled in the art can use the entire contents of any of the cited sources of information to make and use aspects of this invention. Each and every cited source of information is specifically incorporated herein by reference in its entirety. Portions of these sources may be included in this document as allowed or required. However, the meaning of any term or phrase specifically defined or explained in this disclosure shall not be modified by the content of any of the sources. The description and examples that follow are merely exemplary of the scope of this invention and content of this disclosure and do not limit the scope of the invention. In fact, one skilled in the art can devise and construct numerous modifications to the examples listed below without departing from the scope of this invention.

### BRIEF DESCRIPTION OF THE DRAWINGS

FIG. 1 is a flow chart of an exemplary process for making the beverages of the invention and the steps used in such a process.

### DETAILED DESCRIPTION OF EXEMPLARY EMBODIMENTS

In general and as used in this invention, the various cocoa-containing extracts, products or compositions noted here refer to the terms as used in Minifie (Chocolate, Cocoa, and Confectionery, 3d ed., Aspen Publishers), specifically incorporated herein by reference. The cacao bean (or cocoa bean) refers to the cacao bean in nature. Cocoa containing products or bean compositions are products derived from or having some component, but not the separated cocoa butter component, derived from the cocoa bean, fermented cocoa bean, unfermented cocoa bean, blanched cocoa bean, unroasted cocoa bean, and/or fermented and roasted cocoa bean. Cocoa powder refers typically to cocoa solids with a total of 10% to 12% fat, where the fat is cocoa butter. Defatted cocoa powders are cocoa powders with reduced levels of fat or have substantially all fat removed, and particular embodiments of the invention can be made from some or all of defatted cocoa powder or products, and/or some or all of cocoa powders or products containing substantially no cocoa fat. Some of the cocoa powders available contain, for example, about 3% or less cocoa fat, and these can be used in the invention. The compositions and beverages of the invention will be, in most cases, cocoa polyphenol containing and/or cocoa flavanol antioxidant containing beverages and compositions and are generally produced from natural cocoa or cocoa powder, which is the product resulting from pressing the lipid content from chocolate liquor, cacao bean nibs, or fermented and roasted cacao bean nibs. As noted, unroasted and/or unfermented cacao beans or cocoa products made from them can also be used to produce the compositions and beverages of the invention, and several unroasted and/or unfermented cacao products are available for use. In particular, unroasted and unfermented cacao beans, and optionally raw beans that have been briefly heat-treated or blanched, can be used to produce a cocoa powder or other cocoa products that contain high levels of cocoa polyphenols, and the powders, extracts, and concentrates from these unroasted and unfermented beans can be used in particular embodiments of the invention. Also, unroasted raw beans and cocoa products derived from unroasted raw beans can be used, or used in combinations of cocoa powders or products, by incorporating them into ingredients prior to aseptic heating or heating to about 275° to about 290° F. to sterilize the raw beans or products being made. Usually or optionally, a pre-treatment step is used prior to incorporating a raw bean or raw bean product or extract into an aseptic process, for example pre-treating raw beans or material derived from raw beans at about 80° C. for up to 30 minutes. As used herein, the terms “cocoa powder,” “cocoa bean compositions,” and “cocoa products” can mean a product from a cacao bean, regardless of the method or treatment employed to produce the powder, composition or product. In addition, combinations of cocoa products or cocoa powders produced from different types of cacao beans or from different bean processing methods or conditions can be used. In particular, combinations of natural cocoa powder and dutched cocoa powder can be used, and preferred mixtures of these powders have about 15% or about 10% or less alkalized or dutched cocoa powder, as shown in the examples of Table 2. Other cocoa products, such as breakfast cocoa, cocoa syrups, and cocoa liquors can be used. Breakfast cocoa is cocoa solids with 20 to 24% fat, where the fat is cocoa butter. As one of skill in the art understands, a certain amount or percentage of cocoa solids in a food ingredient can be achieved, inter alia, by using or adding an amount of cocoa powder, liquor, or other chocolate or cocoa ingredient containing the requisite amount of cocoa solids. Similarly, a certain amount or percentage of cocoa in a food ingredient can be achieved, inter alia, by using or adding an amount of cocoa powder, chocolate liquor or other chocolate or cocoa ingredient. In addition, while a cocoa containing product having a particular antioxidant or polyphenol level is not required, the invention encompasses the use of cocoa containing products with enhanced, altered, or increased levels of antioxidants or polyphenol compounds as compared to conventional cocoa containing products. A variety of production methods, extraction methods, and the addition of extracts or cocoa-derived polyphenols have been mentioned and can be used by one of ordinary skill in the art to create cocoa beverages and compositions of the invention. Other nutritional, therapeutic, or preventative ingredients can be added as well, as known in the art.

With respect to cocoa polyphenols, numerous studies have indicated a strong inverse correlation between heart disease and the consumption of polyphenol-containing compounds (Vita, J. A., Am J Clin Nutr 81 (Suppl):292S-7S (2005)). Although cocoa beans and the products thereof have been considered to have health promoting properties for thousands of years, dating back to ancient Central American cultures, recent analytical technologies have allowed for characterization of specific chemistry of the cocoa bean (Hurst, W. J. et al., Nature 418: 289-90 (2002)). Analysis of cocoa, the main product of the cacao bean, indicates that it is highly concentrated in certain polyphenol compounds, specifically in the flavanoid family. The most abundant flavanoids in cocoa are the flavanols, including the monomeric forms of epicatechin and catechin, as well as the oligomeric forms of them. The monomeric forms as well as the lower level polymers have been demonstrated to be bioavailable, reaching peak plasma concentrations two hours post-consumption (Baba, S., Free Radic Res 33(5):635-412 (2000)).

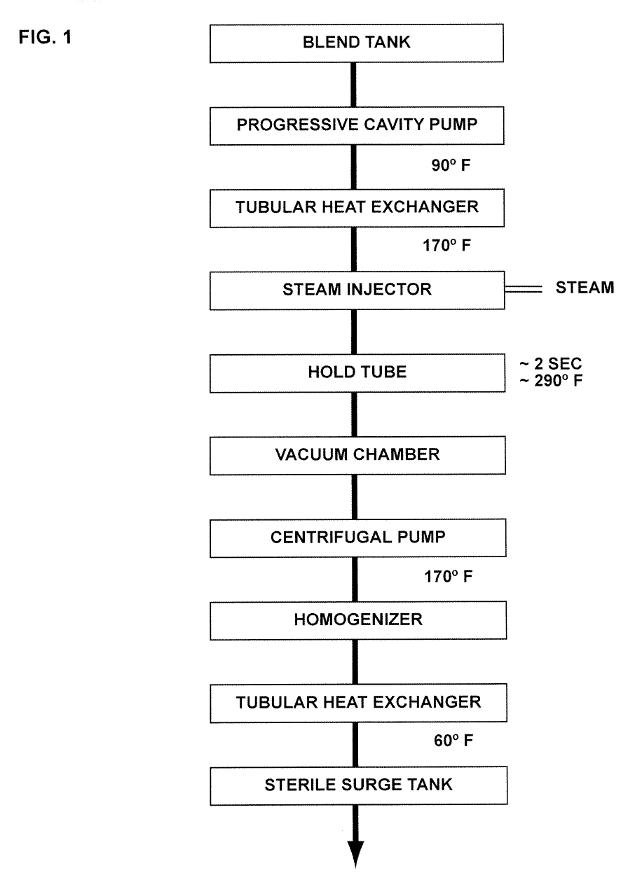

The process shown in FIG. 1 is merely one example of the methods of the invention adapted for sterile fill procedures. The ingredients are added to a blend tank, mixed, and pumped through the system using a pump, for example a progressive capacity pump. The mixture is first used at about 90° F., but other temperatures, such as between about 35° F. to about 170° F. can be used. This flowable mixture is then pumped through a heat exchanger to reach about 170° F. This mixture is then pumped through an ultra high temperature treatment tube, for example at temperatures about 290° F. and about 40-50 psi, typically using a steam heat process. Alternatively, these heating conditions can be between about 275° F. to about 290° F. to sterilize the product. Various hold times for the ultra high temperature treatment can be used, and a preferred time is about 1 second or about 2 seconds, or from about 1 second to about 10 seconds. The mixture can then be cooled and pumped into a homogenizer and then through a second heat exchanger to reduce the temperature. Numerous in-process homogenizing devices are available and can be selected for use. Optionally, final fill additives can be sterile filled on the way to a sterile filling area. Thus, the invention, in one aspect, incorporates the use of an aseptic homogenization step in processing a final product, where the homogenization occurs after an ultra high temperature heating treatment step.

The beverages of the invention can be produced with high levels of cocoa, comparable to about 11 gm/serving of cocoa powder in a dry product, in an 8 oz beverage serving size, and having a density about 1.09 gm/cc and a net weight of 267.9 gms.

Table 1, below, shows the number of grams of cocoa per 8 oz. serving when several different weight percent values of natural cocoa powder are used in the initial mixture.

TABLE 1

| Formula Option (% Natural Cocoa) | Cocoa |
|---|---|
| 3.0% | 7.7 gm/serving |
| 5.0% | 12.9 gm/serving |
| 7.0% | 18.0 gm/serving |
| 9.0% | 23.2 gm/serving |

Several test trials for a low fat milk-based product are shown in Table 2, labeled versions 1 to 4 (V-1 to V-4). The fat, protein, sugar content of these are shown below in Table 3.

TABLE 2

| Ingredient | V-1 | V-2 | V-3 | V-4 |
|---|---|---|---|---|
| Water | 0.00% | 0.00% | 0.00% | 0.00% |
| Milk Low Fat, 1% Fat | 87.00% | 84.00% | 81.00% | 78.00% |
| Sugar | 9.00% | 10.00% | 11.00% | 12.00% |
| Natural Cocoa Powder | 3.00% | 5.00% | 7.00% | 9.00% |
| Alkalized Cocoa Powder | 0.50% | 0.50% | 0.50% | 0.50% |
| Carageenan (Kappa) | 0.010% | 0.010% | 0.010% | 0.010% |
| Salt | 0.020% | 0.020% | 0.020% | 0.020% |
| Vanillin | 0.020% | 0.020% | 0.020% | 0.020% |
| Calcium Carbonate | 0.100% | 0.100% | 0.100% | 0.100% |
| Microcrystalline | 0.350% | 0.350% | 0.350% | 0.350% |
| Cellulose | | | | |
| Total | 100.00% | 100.00% | 100.00% | 100.00% |

TABLE 3

| Serving Size | | | | |
|---|---|---|---|---|
| (8 Fluid oz.) | V-1 | V-2 | V-3 | V-4 |
| Serving Size (grams) | 257.9 | 257.9 | 257.9 | 257.9 |
| KCAL/Serving | 223.9 | 251.5 | 279.2 | 306.9 |
| Protein/Serving | 9.5 | 10.3 | 11.1 | 11.9 |
| Protein % DV | 19% | 21% | 22% | 24% |
| Carbs/Serving | 39.0 | 43.8 | 48.6 | 53.3 |
| Fat/Serving | 3.2 | 3.7 | 4.2 | 4.7 |
| Calcium/Serving | 38% | 38% | 38% | 38% |
| Total Fat % | 1.26% | 1.45% | 1.64% | 1.83% |
| Milk Fat % | 0.87% | 0.84% | 0.81% | 0.78% |
| Milk Solids Non Fat % | 7.57% | 7.31% | 7.05% | 6.79% |
| Total Solids % | 21.4% | 24.1% | 26.8% | 29.6% |
| Sugar Alcohols | — | — | — | — |

A soy-based product can be similarly produced using the ingredients shown in Table 4. Again, an expected density of about 1.09 gm/cc product can be produced.

TABLE 4

| Ingredients | Soy-1 |
|---|---|
| Water | 81.736% |
| Milk, Whole, 3.25% Fat | |
| Milk Reduced Fat, 2% | |
| Fat | |
| Milk Low Fat, 1% Fat | |
| Non-Fat Dry Milk | |
| Skim Milk | |
| Dairy Protein | |
| Erythritol | |
| Liquid Sugar | |
| Sugar | 10.000% |
| Sucralose - Dry | |
| Ace-K - Dry | |
| Natural Cocoa | 2.400% |
| Alkalized Cocoa | 0.400% |
| Micro Cellulose | 0.300% |
| Sweet Flavor | |
| DiSodium Phosphate | |
| Salt | 0.150% |
| Vanillin | 0.023% |
| Vanilla Flavor | 0.100% |
| Calcium Carbonate | |
| Vitamin A/D Blend | |
| Soybean Oil | 0.900% |
| Masking Flavor | 0.200% |
| Soy protein | 3.450% |
| Concentrates | |
| Vitamin Mix | 0.341% |
| Total | 100.00% |

The soy-based products can be made to have the following contents using the same ingredients as above as shown in Table 4. The ingredients listed in Table 4 can be used in any embodiment of the invention. In addition, other flavoring agents, such debitterizing flavor agents, acid masking flavor agents, mouthfeel flavor agents, and other flavors known, used or available for the beverage industry can be selected and used in any embodiment of the invention. Table 5 shows exemplary nutritional information for soy-based beverages. In general, the range of cocoa powder in the soy-based beverages is slightly lower than in the milk-based beverages, but there is no requirement that it be lower than the levels described above.

TABLE 5
Serving Size
(8 Fluid oz.)

| | | | | |
|---|---|---|---|---|
| Serving Size (grams) | 257.9 | 257.9 | 257.9 | 257.9 |
| KCAL/Serving | 178.2 | 157.5 | 178.2 | 157.5 |
| Protein/Serving | 8.3 | 8.3 | 8.3 | 8.3 |
| Protein % DV | 17% | 17% | 17% | 17% |
| Carbs/Serving | 29.5 | 24.3 | 29.5 | 24.3 |
| Fat/Serving | 3.6 | 3.6 | 3.6 | 3.6 |
| Calcium/Serving | 1.1% | 1.1% | 1.1% | 1.1% |
| Total Fat % | 1.38% | 1.38% | 1.38% | 1.38% |
| Milk Fat % | 0.00% | 0.00% | 0.00% | 0.00% |
| MSNF % | 0.00% | 0.00% | 0.00% | 0.00% |
| Total Solids % | 17.8% | 15.8% | 17.8% | 15.8% |
| Sugar Alcohols | — | — | — | — |

Additional processing steps can be incorporated into a production process, including removing substances or particulates by filtration, such as membrane filtration, ultrafiltration, and microfiltration. In general, the milk-based products are buffered at about pH 6.5 to about 6.8, or about pH 6.5 to about 7.0, and various buffering and complexing agents can be used, including ascorbic acid, sodium bicarbonate, citric acid, sodium ascorbate, or other food acids and buffers.

In general, a pressurized process is preferred for certain heating steps, for example to reduce flashing during ultra high temperature treatment, however, certain steps may not require or employ pressure. A variety of pressure ranges are known to and can be used by one of skill in the art in any of the embodiments of the invention.

In addition, centrifugation steps or methods may be used.

The following Tables relate to several tests of finished final product in containers, according to the invention, and the stability of the products, and the stability of the beverage suspension attributes in particular, after storage and other conditions. In Table 6 below, samples 3-6 contain cocoa levels below 2.5% total cocoa powder and are consistent with conventional chocolate milk products. For each of the other samples in Tables 6-9, the products contain about 3% natural cocoa powder by weight and about 0.5% alkalized cocoa powder by weight, or the equivalent in a cocoa solids levels for a cocoa product or cocoa bean-derived product, and certain soy samples listed may contain levels of about 2.4% natural cocoa powder and 0.4% alkalized cocoa powder. Additional ingredients, such as vanilla or vanillin, or coffee for mocha examples, are listed in the names of the samples in the Tables.

TABLE 6

| | | Unshaken | | |
|---|---|---|---|---|
| | Sample | Gel | Separation | Bottom |
| 1 | Extra Dark | 0 | 0 | 0 |
| 2 | Extra Dark - No Sugar Added | 0 | 0 | 0 |
| 3 | Choc Milk | 1 | 0 | 0 |
| 4 | Choc Milk - No Sugar Added | 1 | 0 | 0 |
| 5 | Choc Soy Milk | 0 | 1 | 0 |
| 6 | Mocha Soy Milk | 2 | 0 | 0 |

The samples in Table 6 are an 3.5% total cocoa powder by weight (“Extra Dark” or as EDCS in Tables 7-9) produced with other ingredients as listed. For each of Tables 6-9, the ratings and numbers reported correspond to the following:

Gel
0 No gel formation noticed
1 Slight gel seen when twisting container
2 Slight gel seen when pouring from container
3 Obvious gelation
4 Clumping
5 Complete system failure with visible clumping

Separation
0 No serum separation noticed
1 Slight meniscus on surface
2 Slight meniscus on surface with striation or swirls on side
3 Visible serum which can be poured from surface
4 Surface serum greater than 1 cm
5 Complete system failure with two or more separate and distinct phases

Bottom of Container
0 No cocoa or insolubles on floor
1 Slight dusting on floor
2 Moderate cocoa dusting
3 Heavy dusting, can be shaken back in product with minimal effort
4 Heavy dusting that forms pellet. Does not resuspend with minimal effort
5 Complete system failure with all cocoa and other insolubles on floor. Fluid material clear or white.

Additional groups of samples were similarly tested and the results are presented in the Tables below.

TABLE 7

| Sample | Gel | Separation | Dusting | Notes |
|---|---|---|---|---|
| Dark Choc Soy | 2 | 0 | 1 | OK |
| Extra Dark | 0 | 0 | 0 | Very good |
| Extra Dark - No | 0 | 0 | 0 | Very good |
| Sugar Added (NSA) | | | | |

TABLE 8

| Sample | Gel | Separation | Dusting | Notes |
|---|---|---|---|---|
| EDCS NSA | 0 | 1 | 0 | Good |
| Dark Soy | 2 | 1 | 1 | Fair |
| EDCS NSA | 0 | 0 | 1 | Slight dusting of |
| | | | | cocoa |
| | | | | on floor |
| EDCS | 0 | 0 | 1 | Slight dusting |
| EDCS NSA | 0 | 0 | 1 | Slight dusting |

TABLE 9

| Product | Gel | Separation | Dusting | Notes |
|---|---|---|---|---|
| EDCS | 0 | 0 | 1 | Very good |
| EDCS NSA | 0 | 0 | 1 | Very good |
| Soy Milk - Dark | 3 | 2 | 2 | Gel is strong |
| EDCS NSA | 0 | 0 | 0 | Beautiful |

Some of the samples above have been stability tested up to twelve months from date of original bottling or placing into containers. These products remain in a stable solution, do not show signs of contamination, and retain the beneficial taste, beverage suspension, mouthfeel, and other properties discussed above. In the Tables above, “EDCS” refers to an extra dark chocolate shake-type product or beverage of the invention, and “NSA” refers to no sugar added embodiments. Thus, the ready-to-drink, shelf stable or extended shelf life beverages produced from the methods and examples described above contain a high level of cocoa solids, and thus a high level of cocoa antioxidants. In comparison, prior chocolate milk beverages with very high levels of cocoa contain perhaps up to 12% of a chocolate flavor, typically a chocolate syrup, where chocolate syrup is only about 25% cocoa powder, and where chocolate syrup is typically made from high levels or essentially all alkalized or dutched cocoa products. These could result in perhaps 3% cocoa powder equivalent but only if made with the highest levels of chocolate flavor. Typical chocolate milk formulations have only about 1% cocoa powder and less than about 200 mg total polyphenol per 8 oz serving. Furthermore, these products would contain much lower levels of cocoa antioxidants due to the use of dutched cocoa. The beverages of the invention contain higher levels of cocoa powder, or cocoa solids, use a high percentage of natural cocoa powder that is rich in cocoa antioxidants, and the beverages are stable to room temperature shelf storage. Prior chocolate milk and soymilk beverages fall short in one or more of these categories. Accordingly, the ready-to-drink beverages of the invention are produced from an improved method that results in a better tasting, improved mouthfeel, and much more stable product with high level of beneficial cocoa antioxidants.

Table 10 below reports the measurements of beneficial cocoa antioxidants present in exemplary beverages of the invention, where TP refers to total polyphenols, ORAC is measured at micromoles of Trolox Equivalent per gram, and the serving size is 8 oz.

TABLE 10

| | Density | | ORAC | | ORAC/ |
|---|---|---|---|---|---|
| Sample | (gm/cc) | TPmg/gm | umTE/gm | TP/serving | svg |
| Extra Dark | 1.0777 | 2.18 | 33 | 556 | 8,414 |
| Extra Dark - NSA | 1.0409 | 1.98 | 27 | 488 | 6,649 |
| Extra Dark | 1.07 | 1.70 | 33 | 430 | 8,354 |
| Extra Dark Soy | 1.0617 | 4.15 | 32 | 1,042 | 8,038 |
| Extra Dark - NSA | 1.0405 | 2.79 | 24 | 687 | 5,908 |

For the final product formulation process or manufacturing process of a beverage of the invention, various properties can be controlled for or adjusted, for example, the pH, the concentration of the cocoa component of the beverage and the concentration of the cocoa polyphenols and/or cocoa flavanols, the taste, the sweetness, and the mouthfeel. Color variations can be produced by using dutched cocoa powder and adding coloring agents. In addition, sweeteners, such as sugar, sugar alcohols, saccharides, dextrins, can be used, as well as carrageenans, flavors, emulsifiers, gum arabic, weighting agents, stabilizers or other seasoning agents or flavoring agents can be added, preferably at the initial mixing step, but optionally later. Stabilizers, in general, can be any beverage stabilizer, but preferred are cellulose products and especially preferred are microcrystalline cellulose products.

As mentioned above, various dietary additives, supplements, minerals, and vitamins, and herbal and ingestible extracts can be added to the compositions of the invention, or used in the methods. In particular, a bitter blocker agent or agents, one or more mouth-watering agents, and/or one or more sweetness enhancers can be used. In one such example, an adenosine monophosphate compound can be selected, but any bitter blocker agent or compound known or available can be selected.

Additional food ingredients or edible ingredients can be combined with any of the compositions and combinations of the invention. Especially preferred are one or more of the GRAS (generally recognized as safe) flavoring agents available or known. Organic sweeteners, such as sugars of organic cane juice, can also be used. As noted above, sweetening agents and derivatives thereof can be used, including but not limited to aspartame, acesulfame potassium (Ace-K), saccharine, cyclamate, glycyrrhizine, sucralose, cyclamates, dihydrochalcones, stevisoide, thaumatin, monellin, neohesperidine, and any of the polyol compounds. A preferred polyol or sugar alcohol is erythritol, but any others can be selected, alone or in any of various combinations possible, from, for example, xylitol, mannitol, sorbitol, and maltitol. Sugar substitutes, as known and available in the art, can also be used, alone or in various combinations. In addition, a sweetener or sweetener composition used in any embodiment of the invention can be, for example, sucralose and neotame, alone or in combination. The non-nutritive, high-intensity sugar substitutes in general can also be used, including aspartame, Ace-K, cyclamate, and alitame. Other sugars than can be used in any embodiment of the invention include sucrose, fructose, liquid fructose compositions, especially liquid fructose at about 90% in water, and corn syrups, and combination of these. Sweetness enhancers can also be used, such as vanillin and other compounds available in the art.

As noted herein, some of the beverages are low calorie products, and thus sugar substitutes and sweeteners are preferred, especially in producing products with a per serving calorie count of less than or about 100 calories, or less than or about 70 calories, or less than or about 60 calories, or less than or about 50 calories, or less than or about 40 calories, or less than or about 30 calories, or substantially zero calories.

The examples presented above and the entire content of the application define and describe examples of the many cocoa beverages, compositions, products, and methods that can be produced or used according to the invention. None of the examples and no part of the description should be taken as a specific limitation on the scope of the invention as a whole or of the meaning of the following claims.

What is claimed is:

1. A method of producing a cocoa beverage comprising:
mixing a milk or soymilk liquid, a sweetener, a beverage stabilizing agent, and a cocoa product, the cocoa product present in an amount equivalent to the cocoa solids content present in about 3.5% to about 10% by weight cocoa powder, wherein about 80% or more of the cocoa powder or cocoa product used is not treated with alkalizing conditions, and the milk or soymilk liquid present at about 75% or more by weight;
treating the mixture to ultra high temperature conditions of about 275° to about 290° F. for about 1 second to about 10 seconds;
homogenizing the mixture;
and filling the beverage into a container.

2. The method of claim 1, wherein the cocoa product is a mixture of natural cocoa powder and alkalized cocoa powder, the alkalized cocoa powder present at about 15% or less by weight in the total cocoa product, and wherein an 8 oz. serving of the beverage contains about 500 mg or more of total polyphenols.

3. The method of claim 2, wherein the cocoa product is present at about or the equivalent of 5% to about 5.5% cocoa powder by weight in the final beverage.

4. The method of claim 1, wherein the further comprising filing under aseptic conditions to product an extended shelf life or shelf stable product.

5. The method of claim 1, wherein the beverage stabilizing agent is a microcrystalline cellulose.

6. The method of claim 1, wherein the mixture of milk or soymilk and cocoa product is buffered at about pH 6.5 to about pH 7.0.

7. The method of claim 1, wherein milk is used and the milk is selected from one of whole milk, low fat milk, fractionated milk, or non fat milk.

8. The method of claim 1, wherein the sweetener is selected from one or more of sugar, a sugar alcohol, sucralose, ace-K, erythritol, and aspartame.

9. The method of claim 1, wherein sugar is used in combination with a non-nutritive sweetener.

10. The method of claim 1, further comprising adding a carrageenan.

11. The method of claim 1, further comprising adding an appetite supressant, theobromine, caffeine, a vitamin, or a mineral.

12. The method of claim 1, wherein the cocoa product comprises a cocoa powder from unroasted cocoa beans.

13. The method of claim 1, wherein the cocoa product comprises a cocoa powder or product from unfermented or raw cocoa beans.

14. The method of claim 1, wherein the cocoa product comprises a defatted cocoa powder.

15. A method of producing a stable beverage composition, the beverage composition comprising about 80% or more milk, from about 3.5% to about 10% total cocoa powder by weight, a beverage stabilizer, and a sweetener;
the method comprising adjusting the pH to about pH 6.5 to about 7;
heating the composition to about 275° to about 290° F. for about 1 second to about 10 seconds;
and thereafter homogenizing the composition.

16. A beverage made from the method of claim 15.

17. A beverage made from the method of claim 15, wherein whole milk is used.

18. A beverage made from the method of claim 15, wherein low fat milk is used.

19. A method of producing a stable beverage composition, the beverage composition comprising about 75% or soy milk, from about 3% to about 9% natural cocoa powder by weight, a beverage stabilizer, and a sweetener;
the method comprising adjusting the pH to about pH 6.5 to about 7;
heating the composition to about 275° to about 290° F. for about 1 second to about 10 seconds;
and homogenizing the composition.

20. A beverage made from the method of claim 19.

21. A cocoa beverage composition comprising about 3% or more natural cocoa powder by weight, about 0.5% or more alkalized cocoa powder by weight, about 80% by weight milk product or soymilk product, a sweetener, and a beverage stabilizer, wherein the beverage maintains a stable solution for about twelve months at room temperature storage conditions, and wherein the beverage contains about 500 mg or more of total polyphenols per 8 oz. serving.

22. The beverage of claim 21, wherein one or more of the following is present: whole milk, low fat milk, fractionated milk, or non fat milk.

23. The beverage of claim 21, further comprising one or more of a flavor agent, debitterizing flavor agent, acid mask flavor agent, vitamin A, vitamin D, vanillin, coffee or coffee flavor, salt, and calcium carbonate.

24. The beverage of claim 21, wherein the cocoa product comprises a cocoa powder from unroasted cocoa beans.

25. The beverage of claim 21, wherein the cocoa product comprises a cocoa powder or product from unfermented or raw cocoa beans.

26. A cocoa beverage composition comprising about 2.8% or more total cocoa powder by weight, about 80% by weight soymilk product, a sweetener, and a beverage stabilizer, wherein the beverage maintains a stable solution for about twelve months at room temperature storage conditions, and wherein the beverage contains about 500 mg or more of total polyphenols per 8 oz. serving.

27. The beverage of claim 26, wherein the cocoa product comprises a cocoa powder from unroasted cocoa beans.

28. The beverage of claim 26, wherein the cocoa product comprises a cocoa powder or product from unfermented or raw cocoa beans.
